(19) United States
(12) Patent Application Publication
(10) Pub. No.: US 2020/0203742 A1
(43) Pub. Date: Jun. 25, 2020

(54) METHOD FOR ASSEMBLING A FUEL CELL

(71) Applicant: COMMISSARIAT A L'ENERGIE ATOMIQUE ET AUX ENERGIE ALTERNATIVES, PARIS (FR)

(72) Inventors: Pierrick BUVAT, MONTBAZON (FR); Stéphane CARRIERE, VILLANDRY (FR); Jérôme SERRE, PERTUIS (FR); Paul NGUYEN, TRETS (FR)

(21) Appl. No.: 16/610,589

(22) PCT Filed: May 3, 2018
(86) PCT No.: PCT/FR2018/051108

§ 371 Date: Nov. 4, 2019

(30) Foreign Application Priority Data
May 3, 2017 (FR) 1753908

(51) Int. Cl. H01M 8/1004; H01M 8/0273; H01M 8/0282

(52) U.S. Cl. CPC H01M 8/1004; H01M 2008/1095; H01M 8/0282; H01M 8/0273

(57) ABSTRACT

The invention relates to a method for producing a polymer electrolyte membrane/electrode assembly for a fuel cell comprising the following steps:
providing a first reinforcing membrane (14) comprising an opening (14a), a first electrode (12), a second reinforcing membrane (18) comprising an opening (18a), a second electrode (20), and a polymer electrolyte membrane (16), and
arranging the first (14) and second (18) reinforcing membranes, the first (12) and second (20) electrodes and the polymer electrolyte membrane (16) so as to obtain a successive stack of the first electrode (12), the first reinforcing membrane (14), the polymer electrolyte membrane (16), the second reinforcing membrane (18) and the second electrode (20).

The present invention relates to a method for securing the layers of a fuel cell membranes assembly.

Proton exchange membrane fuel cells, known as PEMFCs, stand for “proton exchange membrane fuel cells” or “polymer electrolyte membrane fuel cells” and have particularly interesting compactness properties. Each cell includes a polymer electrolyte membrane that enables only the passage of protons and not the passage of electrons. The membrane is contacted with an anode on a first side and with a cathode on a second side to form a membrane/electrode assembly called MEA.

The above assembly is generally carried out by successive superposition of the different membranes and electrodes with an interposition of reinforcing membranes to support the assembly. However, to ensure proper mutual positioning of the various elements, it is imperative to ensure optimal positioning of the polymer electrolyte membrane with the reinforcing membrane. One solution would be to use a robotic device that would be able to successively assemble the different elements together. However, a simple successive stacking of the different thicknesses is not sufficient since it requires the use of large quantities of active membrane, which is costly.

The invention more particularly aims at providing a simple, efficient and cost-effective solution to this problem.

To this end, it proposes a method for producing a polymer electrolyte membrane/electrode assembly for fuel cells comprising the following steps:
a) provide a first reinforcing membrane comprising an outer edge and an inner edge delimiting an opening,
b) provide a first electrode capable of closing the opening of the first reinforcing membrane,
c) provide a second reinforcing membrane comprising an outer edge and an inner edge delimiting an opening,
d) provide a second electrode capable of closing the opening of the second reinforcing membrane,
e) provide a polymer electrolyte membrane capable of closing both the opening of the first and second reinforcing membranes,
f) arranging the first and second reinforcing membranes, the first and second electrodes and the polymer electrolyte membrane so as to obtain a successive stacking of the first electrode, the first reinforcing membrane, the polymer electrolyte membrane, the second reinforcing membrane and the second electrode, wherein the opening of the first reinforcing membrane is sealed at the bottom by the first electrode and at the top by the polymer electrolyte membrane, and wherein the opening of the second reinforcing membrane is sealed at the bottom by the polymer electrolyte membrane and at the top by the second electrode.

According to the invention, the method proposes to first provide the different membranes to be assembled to each other, which makes it possible to better optimize the quantity of material used.

In this application, the term “opening” implies a closed contour that has the property of having no end, without being infinite. Similarly, the term “edge” refers to a closed contour that has the property of having no end, without being infinite. The term “sealed” in relation to the term “opening” indicates that the passage through the opening is through the element closing said opening.

Thus, the membrane/electrodes assembly obtained is free of spaces or cavities inside it. In practice, the first electrode and the second electrode are each in contact with the polymer electrolyte membrane.

According to another characteristic, prior to step f), the method comprises a step α) in which the polymer electrolyte membrane is secured to one of the first reinforcing membrane and the second reinforcing membrane and in such a way that it seals the opening of said reinforcing membrane concerned.

This operation of securing of the electrolytic membrane can advantageously be carried out by laser welding.

Thus, according to the invention, the method may consist in placing one of the first reinforcing membrane and the second reinforcing membrane on a support and then unwinding a polymer electrolyte membrane over the opening of said membrane so that it closes the opening of said membrane. In a second step, any folds in the polymer electrolyte membrane are removed and in a subsequent step the outer edge of the polymer electrolyte membrane is secured, for example by laser fusion, to the inner edge of the reinforcing membrane concerned.

In particular, the first reinforcing membrane and the first electrode can be secured together in a step β₁), prior to step f), the opening of the first reinforcing membrane being sealed by the first electrode.

The pre-assembly of the first reinforcing membrane and the first electrode makes it easier to assemble the different thicknesses. Indeed, these two layers are thus assembled simultaneously with the other layers of the assembly.

The step β₁) can be performed by placing the first electrode on a support and arranging the first reinforcing membrane above the first electrode, then securing the first electrode to the first reinforcing membrane. Securing may involve the application of a heating element on the first reinforcing membrane.

The second reinforcing membrane and the second electrode can also be secured together in a step β₂), prior to step f), the opening of the second reinforcing membrane being sealed by the second electrode.

The step β₂ can be performed by placing the second reinforcing membrane on a support and placing the second electrode above the second reinforcing membrane, then securing the second electrode to the second reinforcing membrane. Securing may involve the application of a heating element to the first electrode.

The step α) can consist of a step α₁ in which the polymer electrolyte membrane is secured to the first reinforcing membrane or a step α₂) in which the polymer electrolyte membrane is secured to the second reinforcing membrane. The step α₁) can be performed before the step β₁), the first electrode being arranged opposite the polymer electrolyte membrane relative to the first reinforcing membrane. The step α₂) can be performed before the step β₂), the second electrode being arranged opposite the polymer electrolyte membrane relative to the second reinforcing membrane. Thus, it is understood that the steps β₁) and β₂) are performed with the polymer electrolyte membrane already secured to the first or second reinforcing membrane.

The steps of securing the membranes and the electrode as mentioned above are preferably carried out using a heating punch applied on the superposition of formed layers. It is desirable that the heating element or punch does not come into contact with the membrane to prevent it from sticking to the heating element or punch due to its chemical composition. To do this, it is preferable to apply the heating element or punch directly onto the first electrode or the second electrode.

In a preferred configuration of the invention, the method includes a step α₂) which is performed before the step β₂). In one embodiment, the pre-assembly obtained at the end of step β₁) is placed on a support so that the first electrode is applied to the support, the first reinforcing membrane being arranged above the first electrode. In a later step, the pre-assembly obtained at the end of step β₂) is superimposed on the pre-assembly obtained at the end of step β₁) and the assembly is arranged under a press.

The polymer electrolyte membrane is preferably sized so that its outer edge is inscribed between the inner and outer edges of the first and second reinforcing membranes, thus making it possible to limit the consumption of expensive polymer electrolyte membranes.

The resulting assembly can be compressed and heated at the electrodes only and in their entirety, so as to firmly bond the stack of layers together.

The step of compressing and heating the electrodes can be carried out by means of a first compression base plate of the assembly which is dimensioned in a manner substantially identical to the electrodes. The first compression and heating plate can be mounted on a piston of a first press.

The assembly can be compressed and heated in an annular zone surrounding the electrodes. This annular zone preferably begins immediately outside the outer edges of the first and second electrodes. It can extend outwards to the outer edges of the first and second reinforcing membranes. This compression and heating step can be performed by means of a second compression and heating base plate that has an annular shape. The second compression and heating plate can be mounted on a piston of a second press.

Preferably, compression and heating should be carried out in the central zone and then in the annular zone in order to first secure the membranes together in the active part of the assembly and thus avoid any movement of the reinforcing membranes, electrodes and the polymer electrolyte membrane between them.

Optionally, the step of compressing and heating the electrodes can be followed by a step of securing using heating punches for example in a plurality of locations located at the periphery of the reinforcing membranes. This step can also be initiated at the end of the compression and heating cycle and ended simultaneously or after it. In other words, the step of securing by heating punches precedes the step of heating and compressing the annular zone. This securing step prevents the lower reinforcing membrane from buckling and folding back into itself, leading to the formation of a double thickness of the reinforcing membrane inducing the obtained assembly to be discarded for non-conformity.

The dissociation of the compression and heating operations for each of the central zone including the first and second electrodes and the polymer electrolyte membrane and the annular zone surrounding the electrodes, allows the pressure and temperature exerted to be adapted as best as possible to the components of the layers concerned while ensuring the adherence of each of the layers (membranes or electrodes or reinforcement) in contact. This dissociation is particularly interesting in the case where the annular zone does not include an entire layer of polymer electrolyte membrane, i.e. does not include in any place an overlap of the first reinforcing membrane, the polymer electrolyte membrane and the second reinforcing membrane. In addition, since the thickness of the membranes and electrodes is different, this dissociation ensures a homogeneous distribution of pressure and temperature by avoiding the application of the same pressure and temperature over the entire assembly. Although it might be possible to produce a compression base plate with a recess at the outer edges of the membranes, this is very difficult to achieve by machining given the small thickness of the membranes and electrodes, since this would require very tight producing tolerances, which would necessarily be very costly. In addition, it should be noted that the use of a single compression base plate is also not desirable since it is impossible to guarantee a uniform application of pressure on the different layers since they have different compressibility.

According to another characteristic of the invention, the polymer electrolyte membrane is sized so that the first and second electrodes are inscribed inside the polymer electrolyte membrane.

The method may also include the following steps:
providing a support membrane having an outer edge or contour and an inner edge or contour defining an opening of the membrane, said opening being sized so that the polymer electrolyte membrane can fit into said opening and that the first reinforcing membrane and the second reinforcing membrane can cover the entire inner edge of the support membrane,
arrange the support membrane so that the polymer electrolyte membrane is inscribed in its opening and its inner edge is inserted between the inner and outer edges of the first and second reinforcing membranes.

The method described above avoids the extensive use of polymer electrolyte membranes by using a support membrane with an opening in which the polymer electrolyte membrane can be housed. After applying pressure to the multilayer structure of the first electrode/first reinforcing membrane/polymer electrolyte membrane/second reinforcing membrane/second electrode, the support membrane ensures that this assembly is maintained and can be handled later.

When:
the polymer electrolyte membrane is secured to one of the first reinforcing membrane and second reinforcing membrane and in such a way that it closes the opening of said reinforcing membrane concerned,
the first reinforcing membrane and the first electrode are secured together prior to step f), the opening of the first reinforcing membrane being sealed by the first electrode, and
the second reinforcing membrane and the second electrode are secured together prior to step f), the opening of the second reinforcing membrane being sealed by the second electrode,

The method may also include the following steps:
arrange a free face of the first electrode on a support,
arrange the support membrane so that its inner edge covers the entire outer edge of the first reinforcing membrane,
arrange the second reinforcing membrane so that its outer peripheral edge covers the entire inner edge of the support membrane, with a free face of the second electrode facing outwards and opposite the polymer electrolyte membrane.

It is understood that the assembly can be carried out in a limited number of steps since the first electrode and the first reinforcing membrane are pre-assembled to each other, the second electrode and the second reinforcing membrane are also pre-assembled to each other and the polymer electrolyte membrane is pre-assembled to one of the reinforcing membranes.

According to the method, the supporting membrane can be supported by a frame, for example made of metal, which facilitates handling by handling arms equipped with, for example magnetic gripping means.

When:
the first reinforcing membrane and the first electrode are secured together prior to step f), the opening of the first reinforcing membrane being sealed by the first electrode, and
the second reinforcing membrane and the second electrode are secured together prior to step f), the opening of the second reinforcing membrane being sealed by the second electrode,

The method may also include the following steps:
arrange a free face of the first electrode on a support,
arrange the polymer electrolyte membrane so that it closes the opening 14a of the first reinforcing membrane at the top,
arrange the second reinforcing membrane so that its outer peripheral edge covers the entire inner edge of the support membrane, with a free face of the second electrode facing outwards and opposite the polymer electrolyte membrane.

It is understood that the assembly can be carried out in a limited number of steps since the first electrode and the first reinforcing membrane are pre-assembled to each other, that the second electrode and the second reinforcing membrane are also pre-assembled to each other, the polymer electrolyte membrane being arranged between the two pre-assemblies mentioned above.

In this configuration, the polymer electrolyte membrane extends between two opposite edges of the frame, the periphery of which surrounds the outer edges of the reinforcing membranes. The frame can be made of metallic material.

In a practical embodiment of the invention, the polymer electrolyte membrane is made of protonic conductive polymer. For example, it may consist of polysulfone, polyetherketone or polyphenylene on which proton-conducting groups such as sulfonic acid groups, for instance, are grafted. In particular, polymers consisting of a perfluorinated linear main chain and a side chain with sulfonic acid groups will be used. Among the most well-known are the membranes marketed under the name NAFION® by Dupont et Nemours company or under the names DOW®, FLEMION®, Aciplex®, Aquivion® or Gore by Dow chemicals, Asahi Glass, Solvay and Gore companies. The first and second reinforcing membranes can be made of polyvinyl fluoride (PFA), polyethylene terephthalate (PET) or polyethylene naphthalate (PEN) as examples.

According to another characteristic of the method, it comprises a step of performing a closed contour peripheral cutting surrounding the polymer electrolyte membrane through an annular zone of the assembly comprising exclusively a stack of the first and second reinforcing membranes or a stack of the first reinforcing membrane, the polymer electrolyte membrane and the second reinforcing membrane.

In order to allow the passage of cooling liquids and pure gases for the operation of a fuel cell comprising a plurality of assemblies obtained with the method according to the invention, the assembly may be subjected to a step of making openings in a peripheral area surrounding at least the electrodes and preferably the polymer electrolyte membrane and the first and second electrodes. In the latter case, the orifices do not pass through the polymer electrolyte membrane, which prevents a parasitic circulation of coolant between the membrane and the electrodes since the polymer electrolyte membrane is confined on its entire circumference inside the reinforcing membranes.

The orifices can be arranged between said cut-out and the polymer electrolyte membrane.

According to another characteristic, the method includes a step of mounting a first bipolar plate on a free face of one of the first electrode and the second electrode. The method may include a step of mounting a second bipolar plate on one free face of the other of the first electrode and the second electrode. In the latter configuration, the free faces of the first and second electrodes are covered with a bipolar plate.

The prior assembly with the electrodes outside said assembly, i. e. with the reinforcing membranes between the polymer electrolyte membrane and the electrodes, allows at least one bipolar plate or both bipolar plates to be mounted directly in contact with the free faces of the first and second electrodes, thus ensuring a gap-free contact between each bipolar plate and an electrode. In this way, it is possible to guarantee a better gas exchange through the electrodes, which contributes to improving the energy efficiency of the fuel cell.

The invention will be better understood and other details, characteristics and advantages of the invention will become readily apparent upon reading the following description, given by way of a non limiting example with reference to the appended drawings, wherein:

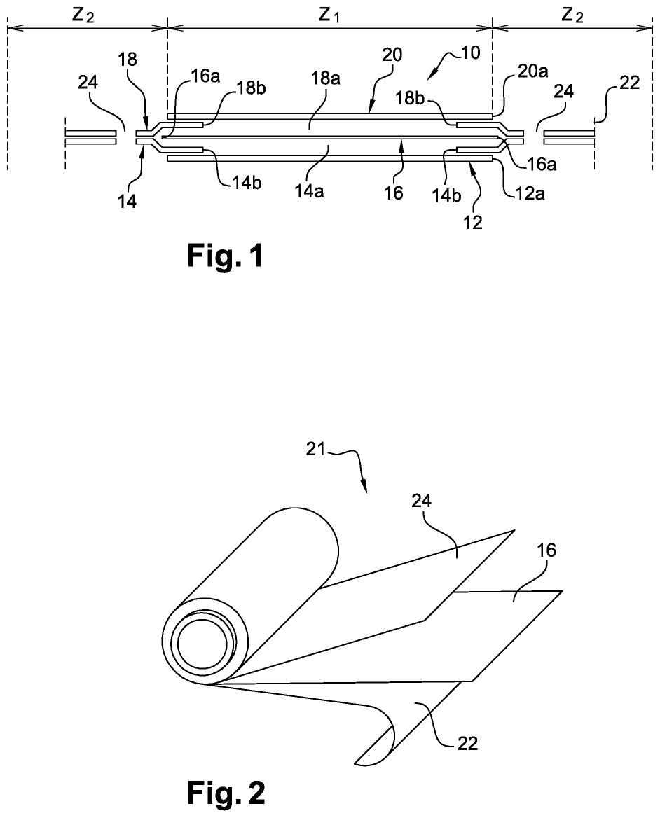

FIG. 1 is a schematic view of an electrode-polymer electrolyte membrane-electrode assembly obtained according to the method of the invention;

FIG. 2 is a schematic perspective view of a multilayer structure roller comprising a polymer electrolyte membrane for fuel cells;

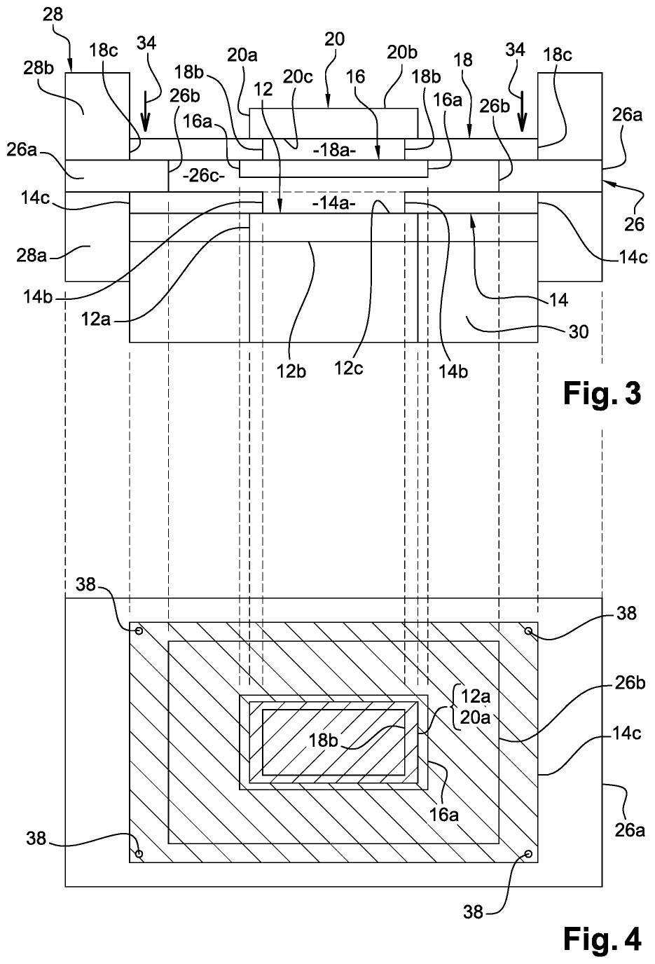

FIG. 3 represents the assembly of the different membranes to form an electrode-polymer electrolyte membrane-electrode assembly according to FIG. 1;

FIG. 4 illustrates the stacking of layers or thickness that can be seen in FIG. 3;

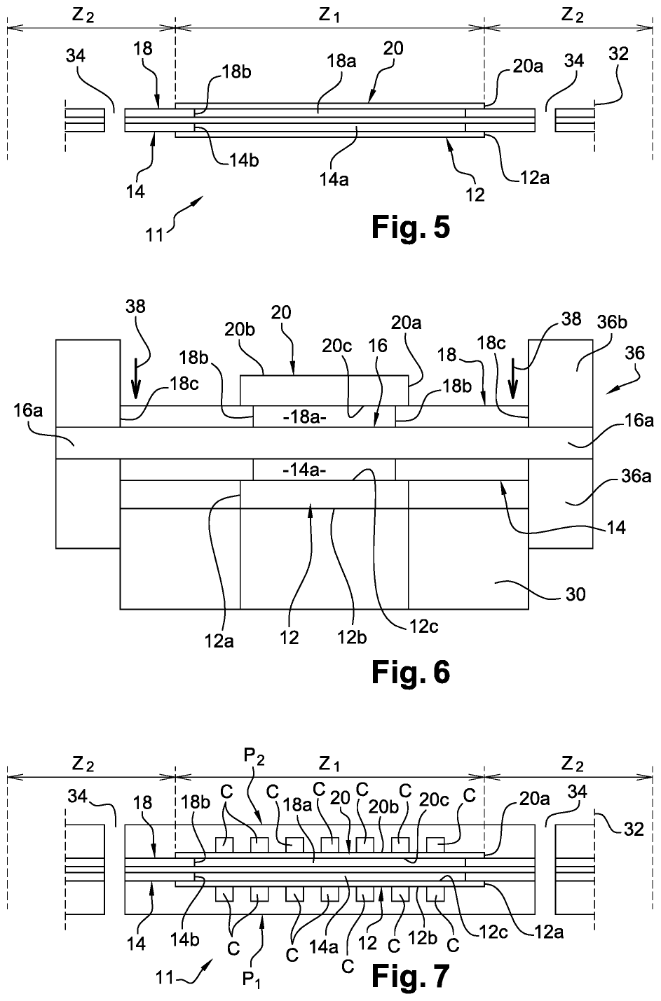

FIG. 5 is a schematic view of another electrode-polymer electrolyte membrane-electrode assembly obtained according to the method of the invention;

FIG. 6 represents the assembly of the different membranes to form an electrode-polymer electrolyte membrane-electrode assembly according to FIG. 5

FIG. 7 is a schematic illustration of the assembly of FIG. 5 and bipolar plates covering said assembly.

First of all, reference is made to FIG. 1, which represents a polymer electrolyte membrane/electrodes assembly 10 called MEA, comprising the successive elements from bottom to top:
a first electrode 12 or lower electrode capable of forming an anode in a fuel cell,
a first membrane 14 or lower reinforcing membrane,
a polymer electrolyte membrane 16 ensuring proton conduction,
a second membrane 18 or upper reinforcing membrane,
a first electrode 20 or lower electrode capable of forming an anode in a fuel cell,

It should be understood that in FIG. 1, the different layers mentioned above are in contact with each other and that the gaps between said layers do not exist in a real assembly.

FIG. 2 shows a roll 21 comprising a multi-layer structure strip having a strip of polymer electrolyte material 16 inserted between a first protective film 22 and a second protective film 24.

The first electrode 12 and the second electrode 20 are in the form of a membrane, for example of a rectangular shape (FIG. 4). Each of the first electrode 12 and second electrode 20 comprises two layers, i.e. a first layer made of a carbon fabric whereon a second catalytic layer comprising a binder integrating a catalyst such as platinum is deposited. The first diffusion layer can have a thickness of about 200 μm and the second layer can have a thickness of about a few tens of microns. The binder may have a similar or identical chemical composition to/with that of the polymer electrolyte membrane 16.

The first electrode 12 and the second electrode 20 have no opening and include an outer edge 12a, 20a defining the outer periphery or outer contour of the electrode 12, 20. The first electrode 12 and the second electrode 20 can have the same shape and dimensions, so that the first electrode 12 and the second electrode 20 are completely interchangeable with each other.

In the assembly shown in FIG. 1 and also in FIG. 3, each electrode 12, 20 comprises a free face 12b, 20b, and a face 12c, 20c, in contact with the polymer electrolyte membrane 16. The free face 12b, 20b, is a face of the first layer or diffusion layer and the face 12c, 20c, in contact with the polymer electrolyte membrane is a face of the second layer of the electrode. Thus, the free faces 12b, 20b, are oriented in a direction opposite the polymer electrolyte membrane 16.

The first reinforcing membrane 14 and the second reinforcing membrane 18 each have a central opening 14a, 18a, delimited by an inner edge 14b, 18b. They also include an outer peripheral edge 14c, 18c, delimiting their periphery or outer contour. The first reinforcing membrane 14 and the second reinforcing membrane 18 can have the same shape and dimensions, so that the first reinforcing membrane 14 and the second reinforcing membrane 18 are totally interchangeable with each other.

The opening 14a of the first reinforcing membrane 14 and the opening 18a of the second reinforcing membrane 18 as well as the electrodes 12, 20 are sized so that the first electrode 12 can completely cover the opening 14a of the first reinforcing membrane 14 in order to close it and the second electrode 20 can completely cover the opening 18a of the second reinforcing membrane 18 in order to close it.

The polymer electrolyte membrane 16 or proton exchange membrane has a substantially rectangular shape and has no opening. It includes an outer edge 16a delimiting the outer periphery or outer contour of the membrane 16. As shown in FIGS. 1 and 3, the polymer electrolyte membrane 16 is sized so that the first 12 and second 20 electrodes are inscribed inside the polymer electrolyte membrane 16. In practice, the polymer electrolyte membrane 16 has a larger surface area than the surface of the first 12 and second 20 electrodes.

As shown in FIG. 3, to make the fuel cell assembly, a support membrane 26 is inserted between the first reinforcing membrane 14 and the second reinforcing membrane 18. This support membrane 26, which can also be described as a transport membrane as it will be easily understood later, includes an outer edge 26a forming the outer contour of the support membrane and an inner edge 26b delimiting a central opening 26c made in the reinforcing membrane 26. The outer edge 26a of the reinforcing membrane 26 is clamped between two metal parts 28a, 28b forming a frame. Thus, the support membrane 26 can be easily handled by means of the two rigid frames fixed to each other by any appropriate means, for example by screwing.

As shown in FIGS. 3 and 4, the opening 26c of the support membrane 26 is sized so that the polymer electrolyte membrane 16 can fit into said opening 26c and so that the outer edge 14c of the first reinforcing membrane 14 and the outer edge 18c of the second reinforcing membrane 18 can cover the entire inner edge 26b of the support membrane 26. In this way, an annular space is created at the connection between the outer edge 16a of the polymer electrolyte membrane 16 and the inner edge 26b of the support membrane 26.

To achieve the above-mentioned stacking of membranes, it is possible to produce the assembly by carrying out the following steps, for example successively but not necessarily:
arrange the first electrode 12 so that its free face 12b is in contact with a support 30,
arrange the first reinforcing membrane 14 above the first electrode 12 so that its opening 14a is sealed at the bottom by the first electrode 12,
arrange the frame 28a, 28b so that the inner edge 26b of the support membrane 26 covers the outer edge 14c of the first reinforcing membrane 14,
arrange the polymer electrolyte membrane 16 in the opening 26c of the reinforcing membrane 26 and so that it closes the opening 14a of the first reinforcing membrane 14 at the top, the edge 16a of the polymer electrolyte membrane facing the inner edge 14b of the first reinforcing membrane 14,
arrange the second reinforcing membrane 18 so that its outer edge 18c covers the inner edge 26b of the reinforcing membrane 26, the inner edge 18b of the second reinforcing membrane 18 being applied over the entire outer edge 16a of the polymer electrolyte membrane 16,
arrange the second electrode 20 above the second reinforcing membrane 18 so that its outer edge 20a applies to the entire inner edge 18b of the second reinforcing membrane 18.

It is understood that some of these steps may be performed before or after some others or may be performed in the order indicated above.

It is still possible to assemble the different layers in a different way by pre-assembling several membranes 14, 16, 18 and electrodes 12, 20 together.

Thus, a first assembly can be constituted by pre-assembling and securing the first electrode 12 with the first reinforcing membrane 14, the free face 12b of the first electrode 12 being arranged opposite the first reinforcing membrane 14. A second assembly can also be constituted by pre-assembling and securing the polymer electrolyte membrane 16 with the second reinforcing membrane 18 and the second electrode 20.

The second assembly can be obtained as follows: First, the second reinforcing membrane 18 is placed on a support of an assembly station that can support the roll 22 of polymer electrolyte membrane 16. The polymer electrolyte membrane 16 is separated from the first 22 and second 24 protective films and pulled until it covers the opening of the second reinforcing membrane 18. Any folds in the polymer electrolyte membrane 16 are then removed.

Finally, in a subsequent step, the outer edge 16a of the polymer electrolyte membrane 16 is secured to the inner edge 18b of the second reinforcing membrane 18.

This securing step can be carried out by laser welding of a first closed contour of the polymer electrolyte membrane 16 on the inner edge 18b of the second reinforcing membrane 18 and then by laser welding of a second closed contour of the polymer electrolyte membrane 16 on the inner edge 18b of the second reinforcing membrane 18, the second contour surrounding the first contour. The power of the laser when making the first weld contour is such that it allows the polymer electrolyte membrane 16 to be secured to the second reinforcing membrane 18 without cutting it. The realization of the second contour is sufficient to allow a welding of the polymer electrolytic membrane 16 on the second reinforcing membrane 18 while allowing a cutting of the electrolytic membrane 16 only, i. e. without cutting the second reinforcing membrane. It should be noted that a single closed contour could also be used to weld the electrolyte membrane with the reinforcing membrane and cut the polymer electrolyte membrane simultaneously.

Once the sub-assembly comprising the polymer electrolyte membrane 16 and the second reinforcing membrane 18 has been formed, the second electrode 20 is assembled on the opening of the second reinforcing membrane 18 so that the second electrode 20 closes the opening 18a of the second reinforcing membrane 18, the free face 20b of the second electrode 20 being oriented opposite the polymer electrolyte membrane 16.

After obtaining the first and second assemblies as described above, the first assembly is then deposited on the support 30, the free face 12b of the first electrode 12 being in contact with the support 20. The frame 28a, 28b supporting the support membrane 26 is arranged above the first reinforcing membrane 14 so that the opening 26c of the support membrane 26 is sealed at the bottom by the first assembly, the inner edge 26b of the support membrane 26 being applied over the entire outer edge 14c of the first reinforcing membrane 14c. The second assembly is then applied above the frame 28a, 28b so that the polymer electrolyte membrane 16 fits into the opening 26c of the support membrane 26, the outer edge 18c of the second reinforcing membrane 18 being applied over the entire inner edge 26b of the support membrane 26.

The above-mentioned support 30 can be the static support of a press.

After obtaining the assembly as shown in FIG. 3, one or more pressing and heating operations are carried out to locally melt the contact faces of the membranes 14, 16, 18 and the electrodes 12, 20.

To do this, a first pressing and heating operation is carried out on the electrodes 12, 20 only and all of them. This first pressing and heating zone is represented in FIG. 4 by dotted hatches and also represented in FIG. 1 by the reference Z1. This first operation is followed by a second pressing and heating operation at an annular zone surrounding the electrodes 12, 20, this annular zone being between the inner edge 26b of the support membrane 26 and the outer edges 12a, 20a of the first 12 and second 20 electrodes. Preferably, the annular zone begins immediately inside [?] outside the outer edges 12a, 20a of the first 12 and second 20 electrodes. This second pressing and heating zone is represented in FIG. 4 by solid line hatching and also represented in FIG. 1 by the reference Z2. The annular zone extends outward to the outer edges 14c, 18c of the first 14 and second 18 reinforcing membranes. The two pressing and heating operations mentioned above as well as the use of a polymer electrolyte membrane 16 inscribed in the opening 26c of the support membrane 26 allows the polymer electrolyte membrane 16 to be confined between the reinforced membranes 14, 18 and the electrodes 12, 20.

The above-mentioned pressing and heating operations can be carried out by means of two separate presses or by means of a single press. However, the use of two presses allows a better control of the temperature and pressure exerted on each of the zones considered.

It is also understood that the frame associated with a support membrane allows the transport of the AME assembly from a first press to a second press. It also allows the transport of the assembly to a cutting station, for example using laser.

The cutting consists in making a peripheral cutting 32 with a closed contour surrounding the polymer electrolyte membrane 16 through an annular zone of the assembly comprising exclusively a stack of the first 14 and second 18 reinforcing membranes (FIG. 1). Holes 34 can also be provided between said peripheral cutout 32 and the outer edge 16a of the polymer electrolyte membrane, these orifices 34 being intended for the passage of cooling liquid and pure gases (H₂ and O₂).

Although not specifically described in reference to the figures, the invention also relates to a method wherein the assembly of FIG. 3 is produced with the polymer electrolyte membrane 16 pre-assembled to the first reinforcing membrane 14 and no longer to the second reinforcing membrane 18.

Also, in one embodiment not shown in the figures, the polymer electrolyte membrane 16 could extend to the inner edge 26b of the support membrane 26. In this case, the peripheral cut-out 32 as well as the orifices 34 are then made in an annular zone surrounding the electrodes and through a thickness comprising the first reinforcing membrane 14, the polymer electrolyte membrane 16 and the second reinforcing membrane 18.

FIG. 5 shows a second assembly 11 that can be carried out with the method described below. The stacking of the different membranes is identical to what has been described in reference to FIG. 1. However, the assembly shown in this figure does not perform an “anti-wicking” function, i.e. the polymer electrolyte membrane is not confined between the first 14 and second 18 reinforcing membranes as explained in reference to FIG. 1, but extends everywhere between the first reinforcing membrane 14 and the second reinforcing membrane 18. In practice, only the polymer electrolyte membrane 16 differs from the assembly described in reference to FIG. 1. To make the assembly shown in FIG. 5, the first and second assemblies are obtained as described above with reference to FIG. 3. The first assembly is then deposited on the support 30, the free face 12b of the first electrode 12 being in contact with the support 20 (FIG. 6). A metal frame 36 formed by two, preferably rectangular, parts 36a, 36b clamps the outer edge 16a of a polymer electrolyte membrane 16. The frame 36a, 36b supporting the polymer electrolyte membrane 26 is arranged above the first reinforcing membrane 14 so that the polymer electrolyte membrane 16 closes the opening 14a of the first reinforcing membrane 14 at the top. The second assembly is then applied above the frame 36a, 36b so that the second reinforcing membrane 18 is applied to the polymer electrolyte membrane 16. The pressing and heating steps are similar to those described above with reference to FIGS. 3 and 4. In this configuration, the annular zone Z2 includes a stack of the first reinforcing membrane 12, the polymer electrolyte membrane 16 and the second reinforcing membrane 18. After pressing the zones Z1 and Z2, a cut is made in a similar way to the one described above.

Optionally, the step of compressing and heating the electrodes can be followed by a step of securing using heating punches for example in a plurality of locations 38 located at the periphery of the reinforcing membranes 14, 18. This step can also be initiated at the end of the compression and heating cycle and ended simultaneously or after it. In other words, the step of securing by heating punches precedes the step of heating and compressing the annular zone. This securing step prevents the lower reinforcing membrane 14 from buckling and folding back into itself, leading to the formation of a double thickness of the reinforcing membrane 14 inducing the assembly 10 or the assembly 11 obtained with the installation 1 disclosed above to be discarded for non-conformity.

FIG. 7 represents the assembly 11 in FIG. 5 which is arranged between two bipolar plates which can also be arranged on either side of the assembly 10 in FIG. 1 so that the description made in relation with FIG. 6 also applies to the assembly of FIG. 10. Thus, as can be seen, a first bipolar plate P1 is mounted on the free face 12b of the first electrode 12 and a second bipolar plate P2 is mounted on the free face 20b of the second electrode 20. The first bipolar plate P1 and the second bipolar plate P2 each comprise grooves which are sealed by the free faces 12b, 20b of the first and second electrodes 12, 20 so as to define channels C for gas circulation according to the operating principle of a fuel cell.

Obtaining an assembly 10 with reference to FIG. 1 or an assembly with reference to FIG. 5, with the electrodes arranged externally, ensures optimal contact of the free faces 12b, 20b of the first and second electrodes 12, 20 with the first and second plates P1, P2, thus ensuring that there is no space between these two parts of the fuel cell. A better gas tightness is achieved between each of the first and second bipolar plates P1, P2 and the first and second electrodes 12, 20. The cooling liquid and pure gas (H₂ et O₂) orifices 34 also pass through the first and second bipolar plates P1, P2.

1.-20. (canceled)

21. A method for producing a polymer electrolyte membrane/electrode assembly for fuel cells comprising the following steps:
a) providing a first reinforcing membrane comprising an outer edge and an inner edge defining an opening,
b) providing a first electrode capable of closing the opening of the first reinforcing membrane,
c) providing a second reinforcing membrane comprising an outer edge and an inner edge defining an opening,
d) providing a second electrode capable of closing the opening of the second reinforcing membrane,
e) providing a polymer electrolyte membrane capable of closing both the opening of the first and second reinforcing membranes,
f) arranging the first and second reinforcing membranes, the first and second electrodes and the polymer electrolyte membrane so as to obtain a successive stack of the first electrode, the first reinforcing membrane, the polymer electrolyte membrane, the second reinforcing membrane and the second electrode, wherein the opening of the first reinforcing membrane is sealed at the bottom by the first electrode and at the top by the polymer electrolyte membrane, and wherein the opening of the second reinforcing membrane is sealed at the bottom by the polymer electrolyte membrane and at the top by the second electrode.

22. A method according to claim 21, wherein, prior to step f), it comprises a step α in which the polymer electrolyte membrane is secured to one of the first reinforcing membrane and the second reinforcing membrane and in such a way that it seals the opening of said concerned reinforcing membrane.

23. A method according to claim 21, wherein the first reinforcing membrane and the first electrode are secured together in a step β₁), prior to step f), the opening of the first reinforcing membrane being sealed by the first electrode.

24. A method according to claim 22, wherein the first reinforcing membrane and the first electrode are secured together in a step β₁), prior to step f), the opening of the first reinforcing membrane being sealed by the first electrode.

25. A method according to claim 24, wherein the step β₁ is carried out by placing the first electrode (on a support and arranging the first reinforcing membrane above the first electrode, and then securing the first electrode to the first reinforcing membrane.

26. A method according to claim 22, wherein the step β₁ is carried out by placing the first electrode (on a support and arranging the first reinforcing membrane above the first electrode, and then securing the first electrode to the first reinforcing membrane.

27. A method according to claim 23, wherein the second reinforcing membrane and the second electrode are secured together in a step β₂), prior to step f), the opening of the second reinforcing membrane being sealed by the second electrode.

28. A method according to claim 27, wherein the step β₂ is performed by placing the second reinforcing membrane on a support and arranging the second electrode above the second reinforcing membrane, and then securing the second electrode to the second reinforcing membrane.

29. A method according to claim 21, wherein the polymer electrolyte membrane is sized so that its outer edge is inscribed between the inner and outer edges of the first and second reinforcing membranes.

30. A method according to of claim 21, wherein the assembly is compressed and heated at the electrodes only and at all of them.

31. A method according to claim 21, wherein the assembly is compressed and heated at an annular zone surrounding the electrodes, optionally preceded by a securing step, using heating punches for example, in a plurality of locations located at the periphery of the reinforced membranes.

32. A method according to claim 21, wherein the polymer electrolyte membrane is sized so that the first and second electrodes are inscribed inside the polymer electrolyte membrane.

33. The method according to claim 25, wherein it comprises the following steps:
providing a support membrane having an outer edge and an inner edge defining an opening of the membrane, said opening being dimensioned so that the polymer electrolyte membrane can fit into said opening and so that the first reinforcing membrane and the second reinforcing membrane can cover the entire inner edge of the support membrane,
arrange the support membrane so that the polymer electrolyte membrane is inscribed in its opening and its inner edge is inserted between the inner and outer edges of the first and second reinforcing membranes.

34. A method according to claim 33, wherein it comprises the following steps:
arrange a free face of the first electrode on a support,
arrange the support membrane so that its inner edge covers the entire outer edge of the first reinforcing membrane,
arrange the second reinforcing membrane so that its outer peripheral edge covers the entire inner edge of the support membrane, one free face of the second electrode facing outwards and opposite the polymer electrolyte membrane.

35. A method according to claim 33, wherein the support membrane is supported by a, for example metallic frame.

36. A method according to claim 34, wherein the support membrane is supported by a, for example metallic frame.

37. A method according to claim 27, wherein it comprises the following steps:
arrange a free face of the first electrode on a support,
arrange the polymer electrolyte membrane so that it closes the opening of the first reinforcing membrane at the top,
arrange the second reinforcing membrane so that its outer peripheral edge covers the entire inner edge of the support membrane, one free face of the second electrode facing outwards and opposite the polymer electrolyte membrane.

38. A method according to claim 37, wherein the polymer electrolyte membrane is supported by a, for example metallic frame.

39. A method according to claim 21, characterized in that it comprises a step of making a closed contour peripheral cutout surrounding the polymer electrolyte membrane through an annular zone of the assembly comprising exclusively a stack of the first and second reinforcing membranes or a stack of the first reinforcing membrane, the polymer electrolyte membrane and the second reinforcing membrane.

40. A method according to claim 21, wherein the assembly is subjected to a step of making orifices in a peripheral zone surrounding the polymer electrolyte membrane and the first and second electrodes.

41. A method according to claim 36, wherein the orifices are arranged between said cut-out and the polymer electrolyte membrane.

42. A method according to claim 21, wherein it comprises a step of mounting a bipolar plate on a free face of one of the first electrode and the second electrode.

43. A method according to claim 42, wherein it comprises a step of mounting a bipolar plate on a free face of the other of the first electrode and the second electrode.
